(19) United States
(12) Patent Application Publication
(10) Pub. No.: US 2010/0233475 A1
(43) Pub. Date: Sep. 16, 2010

(54) MULTIFUNCTIONAL SURFACE TREATMENT

(75) Inventors: Wolfgang Kantner, Schwarzenau (AT); Wolfgang Heep, Woltersdorf (DE); Kristina Durkic, Lillestrom (NO)

Correspondence Address: BIRCH STEWART KOLASCH & BIRCH, PO BOX 747, FALLS CHURCH, VA, 22040-0747, US

(73) Assignee: Dynea OY, Helsinki (FI)

(21) Appl. No.: 12/377,550

(22) PCT Filed: Aug. 30, 2007
(86) PCT No.: PCT/IB2007/002501

§ 371 Date: May 7, 2009

Related U.S. Application Data
(60) Provisional application No. 60/841,224, filed on Aug. 31, 2006.

(51) Int. Cl. B32B 5/16; B27N 3/06; B32B 21/04

(52) U.S. Cl. 428/339; 427/427.4; 427/331; 428/528

(57) ABSTRACT

Low formaldehyde emission wood based panels are described. These wood based panels have an outer surface layer comprised of a resin composition comprising a naturally occurring component or derivative thereof which is chemically bound to an aromatic hydroxyl compound-aldehyde resin (ncPF). The advantages of having an outer surface layer of the resin composition comprising ncPF, is that the outer surface layer can act as a surface sealer to reduce migration of components from the core of the wood based panel to the surface. The outer surface layer is pleasing to the consumer because it forms light colored faces on the wood based panel. It is also a superior surface for after treatment, such as for example, painting, when compared to amino or phenol resins. In addition, the outer surface layer comprising the inventive resin composition comprising ncPF can lend added fire-retardancy to the wood based panel.

### TECHNICAL FIELD OF THE INVENTION

The invention is directed to wood based panels having superior surface properties and low formaldehyde emissions in view of a unique surface layer of the finished wood product containing a resin composition comprising a naturally occurring component or derivative thereof.

### BACKGROUND

The construction of houses and other buildings involves the use of a variety of materials for walls, floorings and other surfaces. Solid hardwood or soft wood boards are highly desired for such surfaces, but solid boards are often prohibitively expensive. Veneer panels have often been used as an alternative for wall surfaces, but such panels pose their own concerns. As trees of the required type, size and quality become more and more scarce, the manufacture of multilayer veneers or plywoods is expensive with high quality veneer panels becoming difficult to obtain.

The competing needs of reasonable construction costs with high quality buildings has led to expanded uses for alternative wood products. For instance, particle board, fiber board, oriented strand board (OSB), hardboard, and other similar boards are formed from wood that may not otherwise be usable in the construction industry. Boards are also formed from particles, chips, flakes or other fragments of wood. These board stock are being used more and more in the construction of buildings, particularly for wall and floor surfaces and sub-surfaces. Such boards have a quality and integrity that is more than adequate for such uses.

Some of these alternative boards are vulnerable to swelling when exposed to moisture or water. These boards have been coated with wax or otherwise treated to avoid the problems with water. Lund U.S. Pat. No. 4,241,133 discloses that wood flakes may be bonded together with a binder. Examples of the binders include urea/formaldehyde resins, phenol/formaldehyde resins, melamine/formaldehyde resins and polyisocyanates. Binder concentrations of between 5 and 12% are disclosed. Waxes may be used for water resistance and preservatives may also be added. Other methods of manufacture of particle and similar boards are disclosed in U.S. Pat. No. 3,164,511 to A. Elmendorf; U.S. Pat. No. 3,391,233 to B. Polovtseff; and U.S. Pat. No. 3,940,230 to E. Potter.

Aminoplast resins like melamine-urea-formaldehyde resins are used as a surface spray on resin-containing wood fibers just before pressing the fibers into medium density hardboard. As the binder resin cures under heat and pressure, the board is provided with its structural properties. Simultaneously, the surface spray resin cures and seals the surface with a hard protective coating. The following references disclose methods of preparing the thermoset resins used as the “The Chemistry of Synthetic Resins” by Carleton Ellis, Reinhold Publishing Co., 1935; “Phenolic Resin Chemistry” by N. J. L. Megson, Academic Press Inc., New York, 1958; “Aminoplasts” by C. P. Vale, Cleaver-Hume Press, Ltd., London, England; and British Pat. No. 480,316.

Often, a wood grain is molded into the board surface during the pressing step. There are times, however, when it is desirable to emboss a wood grain or other pattern into the surface of a finished board containing a surface spray, such as melamine-urea-formaldehyde. See, Book U.S. Pat. No. 4,266,925 which is herein incorporated by reference. The embossing process involves the application of heat and pressure to the surface of the board which fractures the hard, brittle melamine-urea-formaldehyde coating. The resulting surface is unacceptable as well as weakening the cellulosic panel and rendering the surface vulnerable to humidity. Water extractable lignins will migrate to the surface through the fractures thereby causing surface discoloration and yellowing.

Industry has begun to focus on the detrimental affects of the formaldehyde emissions of these resins and the standards for low formaldehyde emissions have become increasingly stringent. Accordingly, the challenge is to provide boards having low formaldehyde emissions while retaining high strength properties and production efficiency. In distinction to the amino(plast) resins described above, phenol-formaldehyde resins have been used and have the advantage of forming lower formaldehyde emission products than amino-formaldehyde resins, but at the cost of lowering the production efficiency. To overcome low performance, it is known practice to use the materials such as natural components to modify the properties of the resins. For example, the brittleness of surface spray coatings has been the subject of some concern in the art. It is known in the art to modify melamine-formaldehyde, urea-formaldehyde, and melamine-urea-formaldehyde polymers with glycols, sugars, and various latexes in attempts to reduce the brittleness of the thermosetting resins. Some attempts have been successful but at the cost of using modifying materials which may volatilize at embossing temperatures or otherwise migrate from the surface coat to leave an uncured, low molecular weight residue on the surface of the press or embossing die surfaces. This buildup results in frequent nonproductive maintenance time for cleaning. Based on this information, it would be expected that the modification of phenol formaldehyde resins by the addition of natural components, might also cause significant detrimental changes in physical and/or chemical properties (such as viscosity or buffer capacity) compared to the original composition, to such an extent as to limit the potential applications of the modified composition.

US 2003/0148084 has attempted to overcome some of the problems associated with the use of natural components in urea formaldehyde, melamine formaldehyde or phenol formaldehyde compositions with the use of a hydrolyzed soy protein. Also, EP 1318000 has proposed the use of natural components in phenol formaldehyde compositions by the cocondensation of wheat and corn derived proteinaceous compositions with the phenol formaldehyde resin. However, these references are limited to the teaching of the use of the composition as an adhesive binder, and do not teach or suggest the use of the resin composition as a surface spray.

The object of the present invention is to overcome the above-described problems of the known resin compositions for surface sprays or coatings by providing a resin composition comprising a naturally occurring component or derivative thereof. This resin composition allows for the formation of high solids, low viscosity and infinite water dilutability. Such compositions have good sprayability and a lighter color, which are desired in such operations as in the production of fiberboards.

The composition is balanced to provide fast cross-linking and a high degree of hardening, and with the subsequently low formaldehyde emission.

Further, the inventive composition has good reactivity and achieves the low formaldehyde emitting products by having a sufficient amount of formaldehyde available for fast cross-linking at a high degree into hydrolysis resistible network which are important for surface sealers and have the advantage of an efficient formaldehyde scavenger available at the right time in the application.

The widening of the raw material portfolio also can have a commercial advantage in lowering the raw material costs of the surface sprays or coatings and can help to reduce the dependence on the existing raw material markets.

### SUMMARY OF THE INVENTION

The present invention is drawn to a wood based panel comprising an outer surface layer composed of a resin composition comprising a naturally occurring component or derivative thereof which is chemically bound to an aromatic hydroxyl compound-aldehyde resin (ncPF). The present invention is also drawn to a process of forming the low formaldehyde emission wood based panel.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this

### DETAILED DESCRIPTION OF THE INVENTION

### Low Formaldehyde Emission Resin Composition

In an embodiment of the invention, is a low formaldehyde emission resin composition which is used as an outer surface layer of wood based panels such as composite boards and comprises a naturally occurring component or derivative thereof which is condensed so as to be chemically (i.e., ionically, by Van der Waals force and/or covalently, preferably covalently) bonded directly or indirectly to an aromatic hydroxyl compound-aldehyde resin (hereinafter referred to as “ncPF”).

The phrase “naturally occurring component or derivative thereof” is used herein as a single collective term to identify a composition comprising a protein and optionally at least one lignin, organic acid, fatty acid and polyol (for example carbohydrates, starch and sugars). The naturally occurring component or derivative thereof can be vegetable, animal or microbiological origin.

It is preferred that the naturally occurring component or derivative thereof is formed in a process of reducing the overall molecular weight in a natural proteinaceous sample of vegetable or animal in a step of extraction and/or a step of performing a bond breaking reaction (such as hydrolysis) to reduce the viscosity of the overall material and thereby form a naturally occurring component or derivative thereof having a water-based protein. Herein, the term “water-based” protein refers to protein(s) which is/are composed of at least one of: i) water soluble protein; ii) a protein which is soluble in a slightly acidic media (e.g., pH of about 4-6.9); and iii) a salt soluble protein. Preferably, the water-based protein is composed of all of the following: i) water soluble proteins; ii) proteins which are soluble in a slightly acidic media (e.g., pH of about 4-6.9); and iii) salt soluble proteins. The naturally occurring component or derivative thereof is essentially free (i.e., may contain trace amounts of up to 1.0 wt % based on the weight of the naturally occurring component or derivative thereof, preferably, less than 0.5 wt %, more preferably less than 0.1 wt %) of proteins which are soluble in ethanol but are not substantially soluble in water, slightly acidic media and salt water media. Gliadins are such ethanol soluble proteins, which form together with glutenins, which are soluble under slightly acidic conditions to give gluten.

The naturally occurring component or derivative thereof can be obtained in a method similar to the method known as corn wet milling. Corn wet milling has been used to separate corn kernels into products such as starch, protein, fiber and oil. Corn wet milling is a two stage process: (a) a steeping process to soften the corn kernel and to facilitate the next step; (b) a wet milling process resulting in purified starch and different co-products such as oil, fiber, and protein. In general, starch recoveries are between 90 to 96%. The remainder of the starch is found in the different co-products. It is this remainder which can be used as the naturally occurring component or derivative thereof.

Other methods of forming the naturally occurring component or derivative thereof are described in WO 2005/074704, which is herein incorporated by reference in its entirety. When the naturally occurring component or derivative thereof is derived from a plant based material, protein and at least one of a carbohydrate, lignin, organic acid, fatty acid and sugar can remain in the material after the extraction procedure and/or bond breaking reaction have been performed. This final composition (the “naturally occurring component or derivative thereof”) will vary depending on type of agriculture species the natural component is sourced from and the way of extraction. When the naturally occurring component is derived from a plant based material, protein and at least one of a carbohydrate, organic acid, fatty acid and sugar can remain in the material after the extraction procedure and/or bond breaking reaction have been performed.

In a most preferred embodiment, the naturally occurring component or derivative thereof is a proteinaceous material isolated from the plant source with water extraction and optionally grinding/milling. Preferably, the isolate has not been exposed to a substantial quantity of chemicals (such as alkali) which hydrolyze the peptide bonds thereby affecting the primary structure of the protein, but the isolate may be denatured, chemically or mechanically, to an extent which affects the secondary and tertiary structure of the protein. In the extraction process, less than 10% of the peptide bonds are broken chemically (irrespective of the percentage of peptide bonds broken by mechanical means) in forming the isolate. Preferably, less than 3% and more preferably, less than 0.1% of the peptide bonds are broken chemically (irrespective of the percentage of peptide bonds broken by mechanical means) in forming the isolate. For example, the method of derivatizing wheat comprises a step of separation based on solubility of the components in water (pure water, salt water, or slightly acidic water) so as to separate the high molecular weight proteins in gluten (such as gliadins and possibly glutenins) and high molecular weight carbohydrates (the insoluble portion) from the lower molecular weight proteins such as albumin and the low molecular weight carbohydrates (soluble portion).

This naturally occurring component or derivative thereof has a solid content concentration of 40-60 wt %, preferably 44-56 wt % as measured by heating the volatiles off in an oven until the weight stabilizes and calculating the weight of the final composition as a percent of the weight of the sample prior to heating. The viscosity of the naturally occurring component or derivative thereof is 100-3000 mPas, preferably 100-300 mPas. In the preferred embodiment of the invention the viscosity is less than 300 mPas. The viscosity measurements used herein are measured with a rotational viscosimeter (Physica MCR301) at a shear rate of 1000 s⁻¹ and temperature 25° C. with a spindle PP50. The amount of protein in the naturally occurring component or derivative thereof is preferably 1-20 wt % solid based on the total weight of solids, more preferably 5-20 wt %, and the amount of carbohydrates is preferably 20-60 wt % based on the total weight of solids, more preferably 30-55 wt %. The pH of the natural component is <7, preferably less than 6 and more preferably less than 4.5.

Preferably, the naturally occurring component or derivative thereof is formed from at least one selected from the group consisting of wheat, corn, rapeseed (canola), soy, rice, etc. More preferably, the naturally occurring component or derivative thereof is formed from wheat and/or corn. Most preferably, the naturally occurring component or derivative thereof is not formed from soy or casein.

The aromatic hydroxyl compound-aldehyde resin component includes curable aldehyde condensation resins such as, for example, phenol-aldehyde resins, resorcinol-aldehyde resins, and the like. Aromatic hydroxyl compounds (sometimes referred to herein using the identifier “P”) which can be used to prepare these condensation-type resins comprise phenol and various modified phenols including amino phenol, the ortho, meta and para cresols, cresylic acid, xylenol, resorcinol, catechol, hydrochinon, bisphenol A, quinol (hydroquinone), pyrogallol (pyrogallic acid), phloroglucinol, or combinations thereof, and the like. Preferably, the aromatic hydroxyl compound is resorcinol, hydrochinon, phenol or bisphenol A. More preferably, the aromatic hydroxyl compound is phenol. These compounds or combinations thereof can be reacted with the various aldehyde compounds (sometimes referred to herein using the identifier “F”), as a class, preferably those having from 1 to about 10 carbon atoms in aliphatic or cycloaliphatic or aromatic or mixed form, to produce the condensation-type resins useful in the invention. Such aldehyde compounds include, for example, formaldehyde, glyoxal, glutaraldehyde, acetaldehyde, propionaldehyde, crotonaldehyde, benzaldehyde, furfuraldehyde, and the like. Formaldehyde is presently preferred.

In an embodiment, the naturally occurring component or derivative thereof is chemically (i.e., ionically, by Van der Waals force and/or covalently, preferably covalently) bound directly or indirectly to the backbone of the aromatic hydroxyl compound-aldehyde resin (ncPF). In addition, the naturally occurring component or derivative thereof can act as a crosslinker between the polymers in the aromatic hydroxyl compound-aldehyde resin. Preferably, it is a protein in the naturally occurring component or derivative thereof, which is bound directly, or indirectly to the backbone of the aromatic hydroxyl compound-aldehyde component.

The viscosity of the ncPF is 20-3500 mPas, preferably from 20-3000 mPas. The amount of solids in the ncPF is 41- 80%, preferably 45-60%. The molar ratio of the ncPF is 1.0:0.1 P/F to 1.0:4.0 P/F. The amount of the naturally occurring component or derivative thereof in the ncPF is 1-60 wt %, preferably 1-50 wt % based on the total weight of ncPF resin.

In an embodiment of the invention, the molar ratio of hydroxyl groups (of the aromatic hydroxyl compound) to aldehyde in the resin composition is 1:0.1 to 1:400. Preferably, the molar ratio is 1:0.9 to 1:80.

The resin composition of the present invention may include components typically used in the art, such as additives, extenders, hardeners (such as ammonium salts like ammonium nitrate), flexibilizers, polyurethanes (such as MDI), other formaldehyde resins (such as urea formaldehyde, melamine(urea)formaldehyde), etc.

The resin composition of the present invention may be stored in a concentrated form which can then be diluted prior to its application to the wood as an outer coating or surface spray. This is advantageous in view of the reduction in storage costs. The viscosity of the composition is at least 10 mPas (for storage). Preferably, the viscosity is 10 to 3500 mPas. Preferably, the concentration of solids is up to 75 wt % based on the weight of the resin composition. More preferably, the concentration is 5 to 70 wt %. Whereas, the viscosity of dilute composition is 1 to 3500 mPas (at time of application). Preferably, the viscosity is 1 to 700mPas. More preferably, 1 to 500 mPas.

### Methods of Forming the Low Formaldehyde Emission Resin Compositions

The resin composition for an outer surface layer of the wood based panels can be made in a variety of methods. For example, the resin composition is made in a process comprising combining the naturally occurring component or derivative thereof, the aromatic hydroxyl compound, and the aldehyde compound in any order in an aqueous media (i.e., aqueous solution wherein all the constituents are not necessarily dissolved) under conditions sufficient to result in the co-condensation of the components.

The description of the naturally occurring component or derivative thereof and the process for preparing the same are given above in the section titled “Low Formaldehyde Emission Resin Composition.”

In an embodiment, the method includes a step of forming an ncPF resin by a first step of forming a PF resin having a weight average molecular weight of at least 200 g/mole, preferably up to 12,000 g/mole, more preferably 200-12,000 g/mole in an aqueous media followed by a second step of adding the naturally occurring component or derivative thereof to the aqueous media to thereby condense the naturally occurring component or derivative thereof with the aromatic hydroxyl-aldehyde resin.

In a preferred embodiment, at least one of the naturally occurring component or derivative thereof and the aromatic hydroxyl compound is methylolated prior to the condensing steps.

The step of condensing the aromatic hydroxyl compound and the aldehyde compound is preferably performed in an aqueous media under neutral to alkali conditions, i.e., pH of 7 to 13. If necessary, the pH can be controlled with organic and/or inorganic base.

In the inventive method, the base is not specifically limited in amount (other than being present in a catalytic amount) or in type, although it is preferably selected from the group consisting of a nitrogenous base such as an ethanolamine (e.g., dimethylethanolamine or diethanolamine), sodium hydroxide, potassium hydroxide, calcium hydroxide, tin compounds (dibutyltin dilaurate, dibutyltin dioctoate and dibutyltin diacetate) and the like. The use of a nitrogenous base is especially preferred because it gives less ash content, does not dilute the product (alkalis have to be used in concentrations not higher than 1N), and overall the final product has better mechanical properties.

It is possible to add additional solvent(s) to the aqueous media to help dissolve the reactants, so long as the additional solvent(s) do not react with the reactants.

### Wood Products Comprising the Inventive Low Formaldehyde Emission Resin Compositions and Processes of Forming the Same

The resin composition comprising ncPF is used in an outer surface layer for wood based panels including composite boards, i.e., particle board, fibreboard, MDF, and oriented strand board.

In certain production methods, initially a mat is made which is used to form an outer wood containing layer. The mat is a layer of wood particles, flakes or fibers (with or without a binder) that are pre-pressed together without added heat (i.e., before the final hot press wherein the product is pressed into its final density). The resin composition comprising ncPF may be applied in the press at any stage before the mat has been consolidated in the final hot press. In an embodiment, the resin composition comprising ncPF can be applied to the surface of the mat prior to pressing, and can be applied to one or both sides of the mat. The resin composition comprising ncPF can be applied to the mat surface in any way. Suitable methods include, but are not limited to, spraying, wet coating, emersion, use of roller, etc.

The resin composition comprising ncPF may be applied to the substrate and/or resinated substrate at any stage from the mat formation until the mat has been consolidated in the final hot press. If necessary, the resin composition comprising ncPF is diluted to the appropriate concentration for coating or surface spray applications. The inventive resin composition comprising ncPF is added to the mat as an outer coating or surface spray at a concentration of 1 to 50% of dry weight, preferably 1 to 35% and more preferably 1 to 25% based on solid dry weight of ncPF resin.

The wood based panel of the present invention comprises an outer surface layer comprising the inventive resin composition comprising ncPF and optionally wood particles, flakes or fibers. Preferably, the wood based panel has at least one layer in the core which does not contain ncPF. Preferably, the at least one layer in the core of the wood based panel that does not contain ncPF comprises at least 30volume % of the total volume of the wood based panel. More preferably, the at least one layer in the core that does not contain ncPF comprises at least 50 volume % of the total volume of the wood based panel. Most preferably, the at least one layer in the core of the wood based panel that does not contain ncPF comprises at least 80 volume % of the total volume of the wood based panel. Preferably, the outer surface layer has a portion which is at least 0.1 mm thick as measured from the outer surface and in a direction normal to the surface of the panel which contains ncPF and no other binder.

In an embodiment, the inventive wood based panel comprises the low formaldehyde emission resin composition which has been applied as an outer surface layer and has a low formaldehyde emission of less than 0.5 mg/L, preferably of 0.01 to 0.3mg/L according to JIS A1460, issued March 2001, or the formaldehyde emission is lower than 0.1 mg/m³ as measured by EN 717-1;

wherein when the panel is a particle board, the particle board meets the mechanical and swelling properties according to standard EN 312, issued October 2003;

wherein when the panel is a fiberboard, the fiberboard meets the mechanical and swelling properties according to standard EN 622-1 issued June 2003;

wherein when the panel is a MDF, the MDF meets the mechanical and swelling properties according to standard EN 622-5 issued December 1997; and

wherein when the panel is an oriented strand board, the oriented strand board meets the mechanical and swelling properties according to standard EN 300, issued September 1997.

The advantages of having an outer surface layer of the inventive resin composition comprising ncPF, is that the outer surface layer can act as a surface sealer to reduce migration of components from the core of the wood based panel to the surface. Also, the inventive outer surface layer can reduce formaldehyde emissions. The inventive outer surface layer is pleasing to the consumer because it forms light colored faces on the wood based panel. It is also a superior surface for after treatment, such as for example, painting, when compared to amino or phenol resins. In addition, the outer surface layer comprising the inventive resin composition comprising ncPF can lend added fire-retardancy to the wood based panel.

### Examples

### Example 1

### Resin Preparation

First, ncPF is prepared. A water-based derivative of wheat (having a concentration (solid content) of 50%, an amount of protein of 7.6% and an amount of sugars of 47.3%, both based on the solids content) is condensed with a phenol and formaldehyde under alkaline conditions to give a F:P ratio of 2.8:1.0 and a content of 20 wt % of the derivative of wheat.

### Example 2

### Description of Amino Resin Suitable for Use in Composite Board to be Surface Treated

A melamine urea formaldehyde resin with a molar ratio F:NH₂ of approximately 0.43 and containing approximately 6% melamine based on liquid resin is prepared in a way well known to those skilled in the art. The resin viscosity is about 250-350 mPas. The concentration (solids content) is approximately 66.5-68.0%. The resin pH is between 8 and 10. The resin is suitable for composite board production.

### Example 3

### Description of Amino Resin Suitable for Use in Composite Board to be Surface Treated

A urea formaldehyde resin with a molar ratio F:NH₂ of approximately 0.47 is prepared in a way well known to those skilled in the art. The resin viscosity is about 200-400 mPas. The concentration (solids content) is approximately 65-68%. The resin pH is between 9 and 11. The resin is suitable for composite board production.

### Example 4

### Application of ncPF as a Surface Spray in Preparation of Single Layer CB to Reduce Formaldehyde Emission from the Finished Board

Boards prepared under the same running conditions were surface treated on both mat faces after mat pre-forming, before pressing and the effect on the finished board properties were tested and compared with non-treated boards.

A single layer composite board at 14 mm and density 670 kg/m³ was made in a laboratory press at press platen temperature of 205° C. and a pressure of 30-40 bar. The pressing time was 7.5 s/mm. The boards were made in a laboratory press according to standard procedures known to those skilled in the art. The mat was pre-formed before surface spraying. The wood fibres were resinated with a resin according to Example 2 or 3. The resin load was 12% based on oven dried wood. An amount of 3% aqueous ammonium nitrate solution based on oven dried resin was added to accelerate the cure speed of the resin.

The pre-formed mat was surface treated by spraying ncPF on both sides of the mat before pressing the mat to form the composite board.

| | Loading of | | | |
|---|---|---|---|---|
| | Amino Resin | | | |
| | on mat (Solid | Surface treatment | | Perforator Value |
| Amino | resin on solid | before pressing the | | according to EN 120, |
| Resin | wood) | mat | Pressing time | corrected to 6.5% m.c. |
| Ex 2 | 12% | None | 7.5 s/mm | 2.2 mg/100 g |
| Ex 2 | 12% | Sprayed 2.5% ncPF | 7.5 s/mm | 1.6 mg/100 g |
| | | of Example 1 on | | |
| | | each side (solid | | |
| | | ncPF on solid resin) | | |
| Ex 3 | 12% | None | 7.5 s/mm | 3.2 mg/100 g |
| Ex 3 | 12% | Sprayed 2.5% ncPF | 7.5 s/mm | 2.4 mg/100 g |
| | | of Example 1 on | | |
| | | each side (solid | | |
| | | ncPF on solid resin) | | |

The data in the above table shows that for different types of amino resins used as a binder in the composite board, the addition of a small amount of the inventive ncPF resin composition as a surface spray will reduce the formaldehyde emissions of the board at equivalent press times.

### Example 5

### Description of Amino Resin Containing Melamine that is Suitable for Use in Composite Board to be Surface Treated

A melamine urea formaldehyde resin with a molar ratio F:NH₂ of approximately 0.48 and containing approximately 3.2 wt % melamine based on liquid resin is prepared in a way well known to those skilled in the art. The resin viscosity is about 180 to 220 mPas. The concentration (solids content) is approximately 66%. The resin pH is between 8 and 10. The resin is suitable for composite board production.

### Example 6

### Application of ncPF as a Surface Spray in Preparation of Single Layer CB to Reduce Formaldehyde Emission from the Finished Board

Boards prepared under the same running conditions were surface treated on both mat faces after mat pre-forming, before pressing and the effect on the finished board properties were tested and compared with non-treated boards.

A single layer composite board at 12 mm and density 640 kg/m³ was made in a laboratory press at press platen temperature of 205° C. The pressing time was 7.5 s/mm. The boards were made in a laboratory press according to standard procedures known to those skilled in the art. The mat was pre-formed before surface spraying. The wood fibers were resinated with a resin according to Example 5. The resin load was 12% based on oven dried wood. An amount of 3% aqueous ammonium nitrate solution based on oven dried resin was added to accelerate the cure speed of the resin.

A pre-formed mat was surface treated by spraying ncPF on both sides of the mat before pressing the mat to form the composite board and this composite board is compared to a similar board prepared without the surface treatment with ncPF.

| | Loading of | | | Desiccator |
|---|---|---|---|---|
| | Amino Resin | | | value |
| | on mat (Solid | Surface treatment | | according |
| Amino | resin on solid | before pressing the | Pressing | to JIS A |
| Resin | wood) | mat | time | 1460 |
| Ex 6 | 12% | None | 7.5 s/mm | 0.532 mg/l |
| Ex 6 | 12% | Sprayed 10 ml/m² | 7.5 s/mm | 0.390 mg/l |
| | | ncPF of Example 1 | | |

The data in the above table shows that the addition of a small amount of the inventive ncPF resin incorporated into a melamine resin composition as a surface spray will reduce the formaldehyde emissions of the board at equivalent press times.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1) A process of forming a low formaldehyde emission wood based panel, comprising applying to an outer surface of the wood based panel a resin composition comprising a cocondensation product (ncPF) of an aromatic hydroxyl compound-aldehyde resin and a naturally occurring component or derivative thereof, wherein the naturally occurring component or derivative thereof is chemically bonded directly or indirectly to the aromatic hydroxyl compound-aldehyde resin.

2) The process of claim 1, wherein the resin composition is applied to the outer surface of the wood based panel as a spray.

3) The process of claim 1, comprising pressing wood particles, flakes and/or fibers without added heat to form a mat.

4) The process of claim 3, further comprising applying a binder to the wood particles, flakes and/or fibers prior to the pressing without added heat.

5) The process of claim 3, further comprising applying the resin composition comprising ncPF to a surface of the mat and pressing the mat with added heat.

6) The process of claim 5, wherein the resin composition comprising ncPF is added to the mat in a concentration of 1 to 25 wt % based on solid ncPF to solid resin content in the mat.

7) The process of claim 1, further comprising:
a step of obtaining the naturally occurring component or derivative thereof as a water-based isolate through isolation from a plant source with water extraction and optional grinding/milling;
condensing an aromatic hydroxyl compound, an aldehyde compound and the water-based isolate in any order to form the ncPF.

8) The process of claim 1, wherein the naturally occurring component or derivative thereof is formed from at least one selected from the group consisting of soy, wheat, corn, rapeseed and rice.

9) The process of claim 1, wherein the naturally occurring component or derivative thereof is formed from wheat and/or corn.

10) The process of claim 1, wherein the aromatic hydroxyl compound-aldehyde resin is at least one phenol-aldehyde resin and resorcinol-aldehyde resin.

11) A wood based panel comprising an outer surface layer composed of a resin composition comprising a naturally occurring component or derivative thereof which is chemically bonded directly or indirectly to an aromatic hydroxyl compound-aldehyde resin (ncPF).

12) The wood based panel of claim 11, having a low formaldehyde emission of 0.01 to 0.3mg/L according to JIS A1460, March 2001.

13) The wood based panel of claim 11, having a low formaldehyde emission of 0.01 to 0.5mg/L according to JIS A1460, March 2001.

14) The wood based panel of claim 11, having a low formaldehyde emission of up to 0.1 mg/m³ according to EN 717-7.

15) The wood based panel of claim 11, comprising at least one layer in a core of the wood based panel which does not contain ncPF.

16) The wood based panel of claim 15, wherein the at least one layer in the core of the wood based panel that does not contain ncPF comprises at least 30 volume % of the total volume of the wood based panel.

17) The wood based panel of claim 11, wherein the outer surface layer has a portion which is at least 0.1 mm thick as measured from the outer surface and in a direction normal to the surface of the panel which contains ncPF and no other binder.
